(19) United States
(12) Patent Application Publication
(10) Pub. No.: US 2025/0162186 A1
(43) Pub. Date: May 22, 2025

(54) CUTTING DEVICE, SLITTING DEVICE, FOOD CUTTING APPARATUS AND FOOD CUTTING METHOD

(71) Applicant: SHENZHEN XIANYU POWER TECHNOLOGY CO., LTD., Shenzhen (CN)

(72) Inventor: Xu Chen, Shenzhen (CN)

(21) Appl. No.: 18/782,130

(22) Filed: Jul. 24, 2024

(30) Foreign Application Priority Data
Nov. 22, 2023 (CN) 2023115725525

(51) Int. Cl. B26D 11/00; B26D 5/34; B26D 7/26; G06V 20/68

(52) U.S. Cl. CPC B26D 11/00; B26D 5/34; B26D 7/2628; B26D 2011/005; B26D 2210/02; G06V 20/68

(57) ABSTRACT

Disclosed are a cutting device, a slitting device, a food cutting apparatus and a food cutting method. The cutting device includes a cutting assembly, a moving assembly and an identification part, the identification part can identify contour information of a food material, and the moving assembly can adjust a relative positional relationship between the food material and the cutting assembly according to the contour information of the food material, thereby achieving a variety of cutting effects on the food material. The slitting device includes a material storage assembly and a slitting assembly, and the slitting assembly is configured to slit the food material passing through the material storage assembly. The food cutting apparatus includes the cutting device and the slitting device, the slitting device can preliminarily slit the food material, and the cutting device is configured to further cut the food material that is slit by the slitting device.

### CROSS-REFERENCE TO RELATED APPLICATIONS

The present disclosure claims priority to and the benefit of Chinese Patent Application No. 202311572552.5 filed Nov. 22, 2023, the contents of which are incorporated herein by reference.

### TECHNICAL FIELD

The present disclosure relates to the technical field of cooking, and in particular to a cutting device, a slitting device, a food cutting apparatus and a food cutting method.

### BACKGROUND

When a general food cutter cuts food, a to-be-cut food material needs to be placed on a conveyor, and a relative movement generates between the food material and a knife through the transmission of the conveyor, thereby adjusting a cutting position on the food material and cutting the food material. The relative movement speed between the conveyor and the knife is usually set to a constant speed, resulting in adjacent cutting positions being closely spaced. Due to different food material shapes, the cutting positions with the same spacing will cause the different volume of the cut food material. In particular, for the food material with complex shape, they need to be manually adjusted in position or shape, therefore the general food cutter does not have adaptability to the food material of different shape, and has a relatively low cutting precision, and is not conducive to improving the cutting efficiency.

### SUMMARY

The present disclosure aims to solve at least one of the technical problems existing in the existing technology. To this end, the present disclosure provides a cutting device that can adjust the cutting position of a knife on a food material according to the shape of the food material, achieve a variety of cutting methods for the food material, and meets various cutting requirements of the food material and improving the cutting fineness and cutting efficiency.

The present disclosure further provides a slitting device.

The present disclosure further provides a food cutting apparatus with the above-mentioned cutting device.

The present disclosure further provides a food cutting method.

According to a first aspect of the present disclosure, an embodiment provides a cutting device including a cutting assembly, a moving assembly and an identification part, and the cutting assembly is configured to cut a food material; the moving assembly includes a fixing part, a driving part, a connecting part and a placing part, the driving part is connected to the fixing part, the connecting part is connected to the driving part, the connecting part is located between the fixing part and the placing part along a first direction, the placing part is arranged adjacent to the cutting assembly along a second direction, the placing part is configured to carry the food material, the driving part is configured to drive the connecting part to be close to or away from the placing part along the first direction, the food material is capable of being fixed between the connecting part and the placing part, and the driving part is also capable of driving the connecting part to be close to or away from the cutting assembly along the second direction for adjusting a cutting position of the cutting assembly on the food material; and the identification part is connected to the fixing part, the identification part is located below the fixing part along the first direction, and the identification part is configured to identify contour information of the food material on the placing part and feed back the contour information to the driving part.

According to the embodiment of the present disclosure, the cutting device has at least the following beneficial effects: the placing part is configured to carry the food material, and the identification part is configured to identify the contour information of the food material on the placing part and feed back the contour information to the driving part. The driving part drives the connecting part to be close to the placing part along the first direction for fixing the food material according to the contour information fed back by the identification part. After fixing the food material, the driving part drives the connecting part to be close to the cutting assembly along the second direction for changing a relative distance between the food material and the cutting assembly, thus the cutting position of the cutting assembly on the food material can be adjusted. Without manually adjusting the position and/or shape of the food material, the cutting device adapts to different cutting requirements for the food material of different shapes, thereby improving the cutting fineness and cutting efficiency of the food material.

According to some embodiments of the present disclosure, the moving assembly further includes a rotating part, the rotating part is connected to the driving part and the connecting part, the driving part drives the rotating part to rotate around the first direction, the rotating part drives the connecting part to rotate, and the connecting part is capable of driving the food material to rotate along an axial direction of rotation of the connecting part, to adjust the cutting position.

According to some embodiments of the present disclosure, the placing part is provided with an avoidance slot extending along the second direction, the avoidance slot is located below the connecting part and arranged corresponding to the connecting part along the first direction, and the avoidance slot is configured to avoid the connecting part.

According to a second aspect of the present disclosure, an embodiment provides a slitting device including a material storage assembly and a slitting assembly, the material storage assembly includes a material storage body, the material storage body is provided with a material inlet, a material outlet and a material storage cavity, the material inlet is configured to allow the food material to enter the material storage cavity, and the material outlet is configured to allow food material to be exposed to the material storage cavity; and

the slitting assembly includes a slitting driving part, a circulating part and a slitting tool, the slitting tool is located on a side of the material storage body that is provided with the material outlet, where the slitting driving part is configured to drive the slitting tool to move along a third direction and pass through the material outlet to slit the food material exposed at the material outlet, the circulating part is configured to drive the slitting tool to move back and forth along the second direction in a process of the slitting tool moving along a third direction, and the second direction intersects with the third direction.

According to the embodiment of the present disclosure, the slitting device has at least the following beneficial effects: under the joint action of the slitting driving part and the circulating part, the slitting tool also includes a reciprocating movement along the second direction when moving along the third direction, thus the slitting tool can slit the food material in a manner similar to manual cutting, which protects the cutting surface of the food material and improving the cutting fineness of the food material.

According to some embodiments of the present disclosure, the slitting tool is connected to the slitting driving part, the slitting driving part is connected to the circulating part, and the circulating part is connected to the slitting tool.

According to some embodiments of the present disclosure, the material storage body is provided with an avoidance part, the avoidance part communicates with the material storage cavity, the slitting device further includes a clamping assembly, the clamping assembly is located at the avoidance part, and the clamping assembly enters the material storage cavity through the avoidance part to fix the food material.

According to some embodiments of the present disclosure, the clamping assembly includes a clamping driving part and at least two clamping parts, the clamping driving part is connected to each of the clamping parts. Along the first direction, the clamping parts are distributed around the material storage body and located at the avoidance part, the clamping driving part drives each of the clamping parts to enter or exit the material storage cavity through the avoidance part, and each of the clamping parts is configured to fix the food material in the material storage cavity.

According to a third aspect of the present disclosure, an embodiment provides a food cutting apparatus including a slitting device and the cutting device in any of the above embodiments, the slitting device includes a material storage assembly and a slitting assembly, the material storage assembly includes a material storage body provided with a material storage cavity for accommodating the food material, a material inlet through which the food material enters the material storage cavity and a material outlet through which the food material is exposed to the material storage cavity; and along the first direction, the slitting assembly is located on the side of the material storage body that is provided with the material outlet, and the slitting assembly is configured to slit the food material exposed at the material outlet; and

the placing part is movable between the slitting assembly and the cutting assembly, and the placing part is configured to carry the food material slit by the slitting assembly and transport the food material to the cutting assembly for cutting.

According to the embodiment of the present disclosure, the food cutting apparatus at least has the following beneficial effects: the slitting device is configured to preliminarily slit the relatively big food material, the cutting device is configured to cut the preliminarily slit food material again, and the identification part included in the cutting device can identify the contour of the food material; the moving assembly adjusts the position of the food material according to the contour information identified by the identification part. Therefore, the food cutting apparatus does not need to manually adjust the position or shape of the food material, has a high cutting fineness, adapts to cut the food material of various shapes, and is helpful to improve the cutting efficiency of the food material.

According to some embodiments of the present disclosure, the slitting assembly includes a slitting driving part and a slitting tool, the slitting driving part is connected to the slitting tool, the slitting tool is located on the side of the material storage body that is provided with the material outlet, the slitting driving part is configured to drive the slitting tool to move along a third direction and pass through the material outlet to slit the food material exposed at the material outlet, and the third direction intersects with the first direction.

According to some embodiments of the present disclosure, the slitting assembly further includes a circulating part. Along the second direction, the circulating part is arranged adjacent to the slitting driving part, the circulating part is connected to the slitting driving part and the slitting tool, the circulating part is configured to drive the slitting tool to move back and forth along the second direction in a process of the slitting tool moving along the third direction, and the second direction intersects with the third direction.

According to some embodiments of the present disclosure, the slitting assembly further includes a circulating part. Along the second direction, the circulating part is arranged adjacent to the slitting driving part, the circulating part is connected to the slitting driving part, the circulating part is configured to drive the slitting driving part to move back and forth along the second direction in a process of the slitting tool moving along the third direction, and the second direction intersects with the third direction.

According to some embodiments of the present disclosure, the slitting device further includes a clamping assembly, the material storage body is provided with an avoidance part, the clamping assembly is located at the avoidance part, the avoidance part communicates with the material storage cavity, the clamping assembly is capable of entering or exiting the material storage cavity through the avoidance part, and the clamping assembly enters the material storage cavity for fixing the food material.

According to some embodiments of the present disclosure, the clamping assembly includes a clamping driving part and at least two clamping parts, the clamping driving part is connected to each of the clamping parts; and along the first direction, the clamping parts are distributed around the material storage body and located at the avoidance part, the clamping driving part drives each of the clamping parts to enter or exit the material storage cavity through the avoidance part for fixing or releasing the food material.

The present disclosure further provides a food cutting method, which uses any of the above-mentioned food cutting apparatus to cut food, and the food cutting method includes:
feeding materials: putting a food material into a material storage cavity from a material inlet so that the food material in the material storage cavity is exposed from a material outlet;
slitting and transporting: slitting the food material exposed at the material outlet into a to-be-slit part and a slit part through a slitting assembly, the to-be-slit part being located in the material storage cavity, the slit part being located on a placing part, and the placing part transporting the slit part to a cutting device; and
scanning and cutting: at the position of the cutting device, an identification part photographing the slit part to obtain contour information of the slit part, the placing part transporting the food material to a connecting part, a driving part driving the connecting part to be close to and fix the slit part along a first direction according to the contour information, the connecting part driving the slit part to be close to a cutting assembly along a second direction, adjusting a relative position of the slit part and the cutting assembly to change a cutting position of the cutting assembly on the slit part, and the cutting assembly cutting the slit part.

According to the embodiment of the present disclosure, the food cutting method has at least the following beneficial effects: the food material can be slit and cut separately through the above-mentioned food cutting method, the relatively big food material is slit to become a relatively small volume in the slitting and transporting step, thereby facilitating the subsequent cutting. In the scanning and cutting step, the outer contour of the slit food material can be photographed and identified, and the relative position between the food material and the cutting assembly is adjusted according to the identified contour information, thus achieving operations such as dicing, slicing, and peeling of the food material. Therefore, processing the food material through the above-mentioned food cutting method improves the food cutting efficiency, and is helpful to improve the cutting fineness of the food material and improve the cutting quality of the food material.

According to the food cutting method of the embodiment of the present disclosure, an avoidance part is provided on a side wall of the material storage body, in the slitting and transporting step, a clamping assembly is configured to fix the to-be-slit part, and the clamping assembly enters the material storage cavity through the avoidance part for fixing the to-be-slit part.

According to the food cutting method of the embodiment of the present disclosure, the slitting assembly includes a slitting tool. In the slitting and transporting step, the slitting tool is enabled to move along the third direction and pass through the material outlet, the food material exposed from the material outlet is slit to form the to-be-slit part and the slit part, the slitting tool is also enabled to move back and forth along the second direction in a process of moving along the third direction, and the second direction intersects with the third direction.

According to the food cutting method of the embodiment of the present disclosure, in the scanning and cutting step, when the food material is close to the cutting assembly along the second direction, the connecting part can also drive the food material to rotate, thereby adjusting the relative position between the food material and the cutting assembly.

The additional aspects and advantages of the present disclosure will be set forth in the description below, some will be obvious from the description below, or be understood from the practice of the present disclosure.

### BRIEF DESCRIPTION OF DRAWINGS

The present disclosure will be further described below in conjunction with the accompanying drawings and embodiments, where:

FIG. 1 is a front view of a food cutting apparatus according to an embodiment of the present disclosure.

FIG. 2 is a schematic structural view of a cutting device according to an embodiment of the present disclosure.

FIG. 3 is a side view of a cutting device according to an embodiment of the present disclosure.

FIG. 4 is a rear view of a cutting device according to an embodiment of the present disclosure.

FIG. 5 is a schematic structural view of a food cutting apparatus according to an embodiment of the present disclosure.

FIG. 6 is a top view of a slitting device according to an embodiment of the present disclosure.

FIG. 7 is a bottom view of a slitting device according to an embodiment of the present disclosure.

FIG. 8 is a front view of a slitting device according to an embodiment of the present disclosure.

### REFERENCE NUMERALS

cutting device 100, cutting assembly 110; moving assembly 120, fixing part 121, driving part 122, first motor 1221, second motor 1222, third motor 1223, connecting part 123, placing part 124, avoidance slot 1241, identification part 125, rotating part 126;
slitting device 200, material storage assembly 210, material storage body 211, material inlet 212, material outlet 213, material storage cavity 214, avoidance part 215, slitting assembly 220, slitting driving part 221, slitting tool 222, circulating part 223, clamping assembly 230, clamping driving part 231, clamping part 232;
food cutting apparatus 300.

### DETAILED DESCRIPTION

The embodiment of the present disclosure is described in detail below, the example of the embodiment is shown in the drawings, and from beginning to end, the same or similar signs indicate the same or similar components or components with same or similar function. The embodiment described with reference to the drawings is exemplary, which is merely configured to explain the present disclosure, instead of being understood as a limitation to the present disclosure.

In the description of the present disclosure, it is understood that, when involving an orientation description, orientation or position relationships indicated by the terms “upper”, “lower”, “front”, “rear”, “left”, and “left”, and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In the description of the present disclosure, the meaning of “several” is one or more, the meaning of “a plurality” is more than two, “greater than”, “less than”, “exceeding” and the like are understood as excluding the original number, and “above”, “below”, “within” and the like are understood as including the original number. The described “first” and “second” are merely used for distinguishing technical features, instead of being understood as indicating or implying relative importance or impliedly indicating the quantity of the showed technical features or impliedly indicating the precedence relationship of the showed technical features.

In the description of the present disclosure, unless specific limitation otherwise, terms “set”, “install”, “join” and the like should be generally understood. Those of ordinary skill in the art may reasonably determine the specific meaning of the terms in the present disclosure in combination with the specific contents of the technical solution.

In the description of the present disclosure, the descriptions of reference terms “one embodiment”, “some embodiments”, “schematic embodiment”, “example”, “specific example”, or “some examples” intend to be included in at least one embodiment or example of the present disclosure in combination with the specific characteristics, structures, materials or characteristics of this embodiment or example. In this specification, the schematic expression of the above terms does not need for the same embodiment or example. Moreover, the described specific characteristics, structures, materials or characteristics may be combined in one or more embodiments or examples in a suitable manner.

Various embodiments of the present disclosure are described in detail below in combination with the drawings of the specification.

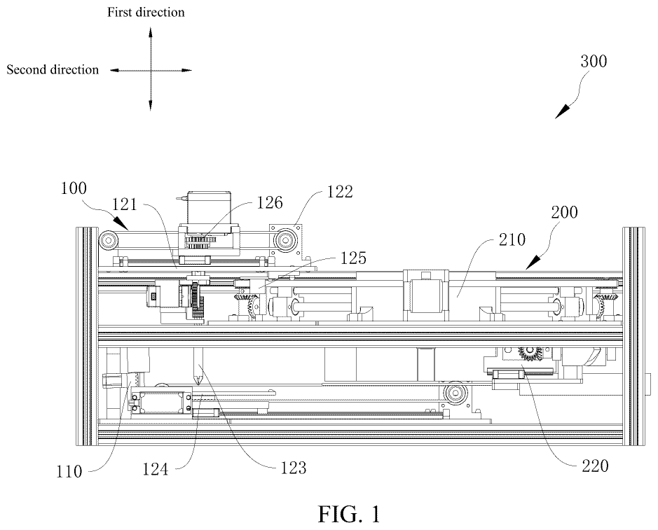

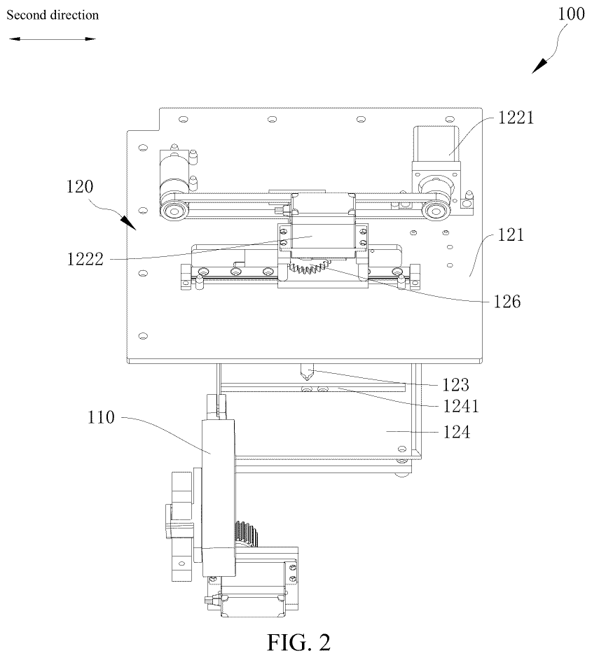

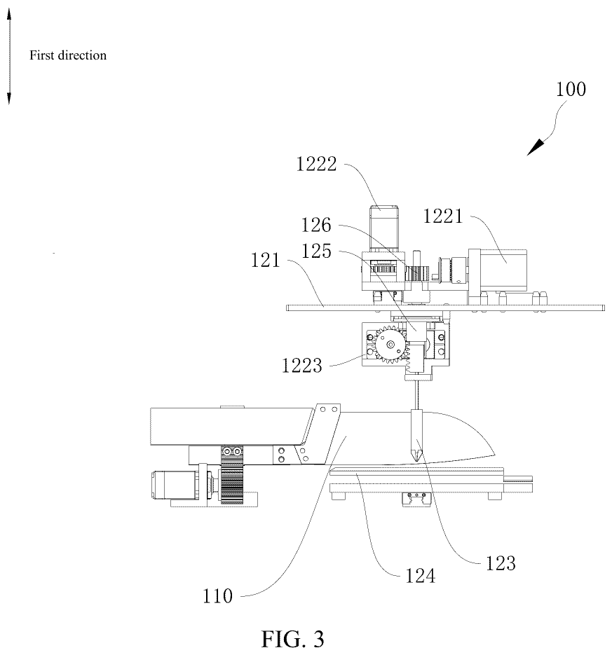

Referring to FIGS. 1 to 3, according to the embodiment in the first aspect of the present disclosure, the cutting device 100 includes a cutting assembly 110, a moving assembly 120 and an identification part 125, where the cutting assembly 110 is configured to cut a food material, the moving assembly 120 includes a fixing part 121, a driving part 122, a connecting part 123 and a placing part 124. The driving part 122 is connected to the fixing part 121, the connecting part 123 is connected to the driving part 122, the connecting part 123 is located between the fixing part 121 and the placing part 124 along a first direction, the placing part 124 is arranged adjacent to the cutting assembly 110 along a second direction. The placing part 124 is configured to carry the food material, the driving part 122 drives the connecting part 123 to be close to or away from the placing part 124 along the first direction. The connecting part 123 can fix the food material when being close to the placing part 124 and separate from the food material when being away from the placing part 124, or the connecting part 123 can drive the food material to move along the first direction, the driving part 122 is also capable of driving the connecting part 123 to be close to or away from the cutting assembly 110 along the second direction. After the connecting part 123 fixing the food material, the connecting part 123 drives the food material to be close to or away from the cutting assembly 110 along the second direction, to adjust a cutting position of the cutting assembly 110 on the food material, thereby achieving various cutting methods such as dicing and slicing the food material.

It should be noted that the connecting part 123 drives the food material to move along the second direction to be close to the cutting assembly 110, and the movement of the connecting part 123 may be continuous or intermittent. If the connecting part 123 moves continuously, the connecting part 123 can accelerate or move at a constant speed, the accelerated movement of the connecting part 123 can cut the food material into gradually increased blocks, the constant movement of the connecting part 123 can cut the food material into more uniform blocks, and a sliding thickness of the food material may also be adjusted by controlling the moving speed of the connecting part 123.

The identification part 125 is connected to the fixing part 121. Along the first direction, the identification part 125 is located below the fixing part 121, the identification range of the identification part 125 can completely cover the placing part 124, the identification part 125 is configured to identify contour information of the food material on the placing part 124 and feed back the identified contour information of the food material to the driving part 122. The driving part 122 drives the connecting part 123 to move according to the contour information to determine different cutting positions according to the food material of different shapes, thus increasing the cutting adaptability of the food material of different shapes, allowing the sizes of the various parts of the cut food material to be relatively close to each other, and facilitating cooking and processing. During this period, there is no need to manually adjust the position or shape of the food material, which improves the cutting efficiency of the food material.

For example, along the second direction, the cutting assembly 110 is arranged adjacent to the placing part 124, the food material is placed on the placing part 124, the placing part 124 provides support for the cutting assembly 110 to cut the food material. The cutting assembly 110 includes a motor and a cutting tool, the motor is drivingly connected to the cutting tool through a gear and rack, under the switch of the positive and negative rotation of the motor, the cutting tool can cut up and down along the first direction, the cutting tool cuts down along the first direction, and after cutting the food material, the cutting tool resets up, completing a cutting cycle. Along the first direction, the connecting part 123 is arranged above the placing part 124, the fixing part 121 and the driving part 122 are arranged above the connecting part 123, and the driving part 122 is fixed to the fixing part 121. Along the first direction, the driving part 122 includes a first motor 1221 located above the fixing part 121, the first motor 1221 and another synchronous wheel are driven by a synchronous belt, a part of the connecting part 123 is clamped on the synchronous belt, thereby achieving the movement of the connecting part 123 along the second direction. Along the first direction, the driving part 122 also includes a third motor 1223 located below the fixing part 121, the third motor 1223 is connected to the connecting part 123 through the gear and the rack, the third motor 1223 is configured to drive the connecting part to move up and down along the first direction. Therefore, the moving assembly 120 can move the food material in two directions and adjust the cutting position of the food material, which improves the adaptability to the shape of the food material.

Along the first direction, the identification part 125 is also provided below the fixing part 121, the identification part 125 includes a camera module that can photograph the food material and is communicatively connected to a visual terminal processing system, food material photos taken by the camera module are uploaded to the visual terminal processing system to be identified, thus extracting the contour information of the food material. The driving part 122 drives the connecting part 123 to move according to the contour information, the movement of the connecting part 123 includes up and down movements along the first direction and left and right movements along the second direction, the connecting part 123 approaches to and fixes the food material on the placing part 124 along the first direction. After fixing the food material, the connecting part 123 moves closely to the cutting assembly 110 along the second direction under the drive of the driving part 122, thus adjusting the cutting position of the cutting assembly 110 on the food material, each cutting of the food material can have the same or different intervals. By adjusting the cutting position of the food material, the cutting assembly 110 can cut the food material into a plurality of food materials with the same or different volumes, especially for food material of irregular shapes. Adjusting the cutting position can improve the volume uniformity of the food material after being cut, and is convenient for cooking the food material.

For example, the contour information of the above-mentioned food material can be a coordinate of the food material along the second direction with the cutting assembly 110 as an origin, the outer contour edge of the food material can have different coordinate information at various places, and the coordinate information fed back to the driving part should be an absolute value. According to the coordinate information, the driving part 122 drives the connecting part 123 to move along the second direction, the connecting part 123 drives the food material to be close to the cutting assembly 110, the movement displacement of the connecting part 123 should be the sum of the numerical values of the coordinate information at the outer contour edge of the food material and the required cutting thickness of the food material. The displacement of the connecting portion 123 along the second direction is determined according to the required cutting thickness and the coordinate information at the outer contour edge of the food material, which improves the cutting uniformity of the food material with different outer contours.

It should be noted that the above coordinate information will change as the outer contour of the food material changes and the connecting part 123 drives the food material to move, the identification part 125 calculates the movement displacement required by the connecting part 123 based on an initial position of the food material on the placing part 124. For example, if the initial coordinate of the outer contour somewhere on the outer contour of the food material is a, and the cutting thickness of the food material is b, then the displacement that the connecting part 123 drives the food material to face the cutting assembly 110 along the second direction is the sum of a and b, and then the displacement that the connecting part 123 drives the food material to face the cutting assembly 110 along the second direction every time the food material is cut is b, to obtain the food material with a thickness b.

Further, the food material can also be cut into food materials of different thicknesses. For example, if the cutting thickness of the food material is required to be two thicknesses b and c, and the initial coordinate of the outer contour somewhere on the outer contour of the food material is a, then the displacement that the connecting part 123 drives the food material to face the cutting assembly 110 along the second direction is the sum of a and b, and then the displacement that the connecting part 123 drives the food material to face the cutting assembly 110 along the second direction every time the food material is cut is b and c alternately, to obtain the food material with thicknesses b and c.

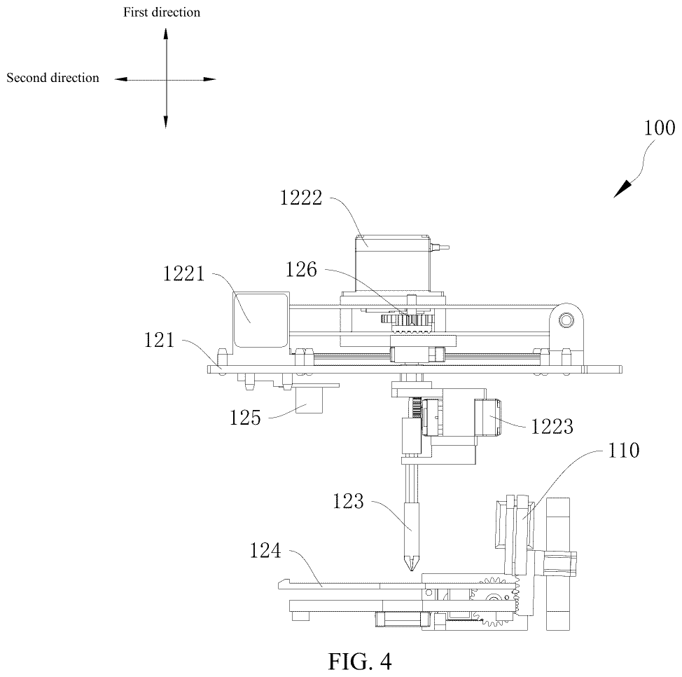

Referring to FIGS. 1 to 4, in some embodiments, the moving assembly 120 further includes a rotating part 126. The rotating part 126 is connected to the driving part 122 and the connecting part 123, the driving part 122 drives the rotating part 126 to rotate around the first direction, the rotating part 126 drives the connecting part 123 to rotate, the connecting part 123 can drive the food material to rotate, which is configured to adjust the cutting position of the cutting assembly 110 on the food material and avoid cutting dead ends occurred when cutting the food material. Under the joint action of the driving part 122, the rotating part 126 and the connecting part 123, the connecting part 123 includes up and down movements along the first direction, left and right movements along the second direction and a rotation with the first direction as an axial direction, which is helpful to better adjust the relative position between the food material and the cutting assembly 110, so that the cutting position of the cutting assembly 110 on the food material can be further adjusted.

For example, the connecting part 123 can drive the food material to be close to the cutting assembly 110 along the second direction, then the connecting part 123 can drive the food material to rotate around the first direction, and the cutting assembly 110 can peel the food material. It should be understood that, during peeling, the identification part 125 can identify the outer contour of the food material and feed back the identified contour information to the driving part 122, the driving part 122 drives the rotating part 126 and the connecting part 123 to adjust the cutting position of the food material, which achieves the refined cutting of the food material and improves the cutting quality of the food material.

Specifically, the outer contour edge of the food material also has a coordinate value along the third direction, and the coordinate value in the third direction affects a circumferential cutting position in a rotation direction of the connecting part 123. It should be understood that the outer contour of the food material cut by the cutting assembly 110 is closer to a circle if the connecting part 123 has a relatively high rotation precision. When the connecting part 123 drives the food material to reach the cutting position of the cutting assembly 110, the connecting part 123 drives the food material to rotate and the cutting assembly 110 to cut the food material alternately, thus cutting the outer contour edge of the food material and peeling the food material can be achieved.

It should be noted that after the connecting part 123 is coupled with the food material, the rotating part 126 drives the connecting part 123 to rotate, and then the connecting part 123 drives the food material to rotate. The rotation of the food material facilitates the identification part 125 to better identify the outer contour of the food material, and reduces the identification blind area of the identification part 125, and accurate identification for the contours of the food material can be achieved to improve the cutting fineness of the food material.

Referring to FIGS. 1 to 4, in some embodiments, the placing part 124 is provided with an avoidance slot 1241 extending along the second direction, along the first direction, the avoidance slot 1241 is located below the connecting part 123 and arranged corresponding to the connecting part 123, and the avoidance slot 1241 can accommodate a part of the connecting part 123. Specifically, when the connecting part 123 fixes the food material on the placing part 124, the connecting part 123 moves downward and approaches to the food material along the first direction, and the connecting part 123 can penetrate through the food material and is coupled with the food material. Along the first direction, the exposed part of the connecting part 123 is placed in the avoidance slot 1241, the avoidance slot 1241 is configured to avoid the part of the connecting part 123. Compared with the placing part 124 not provided with the avoidance slot 1241, the arrangement of the avoidance slot 1241 can ensure that the connecting part 123 completely penetrate through the food material, which facilitates better fixation of the food material and is beneficial to better cutting the food material.

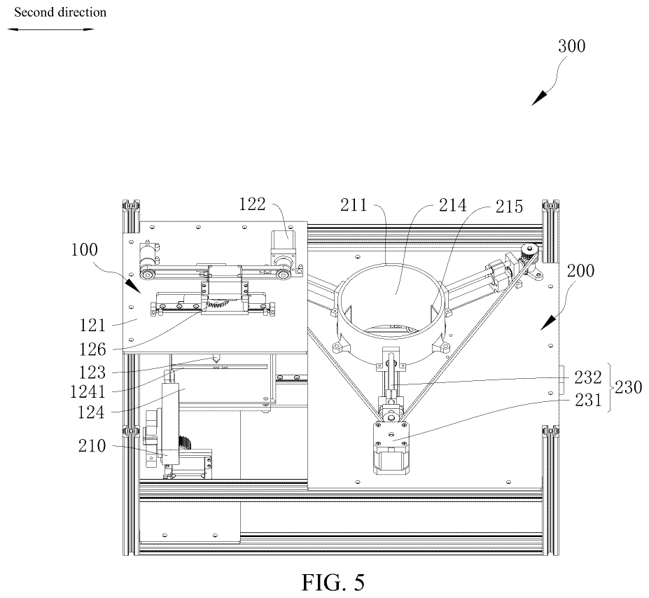

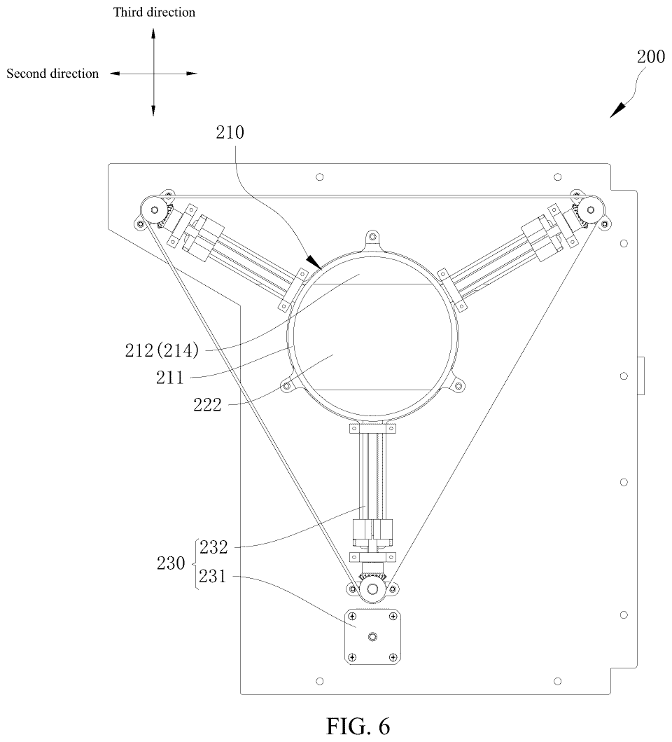

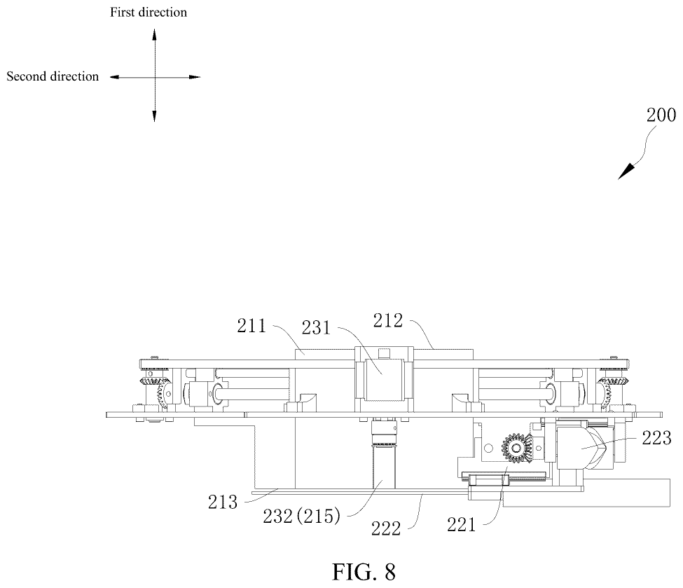

Referring to FIGS. 5 to 8, according to the embodiment in the second aspect of the present disclosure, the slitting device 200 includes a material storage assembly 210 and a slitting assembly 220, the material storage assembly 210 includes a material storage body 211. The material storage body 211 is provided with a material inlet 212, a material outlet 213 and a material storage cavity 214, the material inlet 212 is configured to allow the food material to enter the material storage cavity 214, the material outlet 213 is configured to allow the food material to expose at the material storage cavity 214, the slitting assembly 220 is located below the material storage body 211. The slitting assembly 220 includes a slitting driving part 221, a circulating part 223 and a slitting tool 222, the slitting driving part 221 is connected to the slitting tool 222. Along the second direction, the circulating part 223 is connected to and arranged adjacent to the slitting driving part 221, the circulating part 223 is also connected to the slitting tool 222, the circulating part 223 drives the slitting tool 222 to move back and forth along the second direction. When the slitting driving part 221 drives the slitting tool 222 to move along the third direction, the slitting tool 222 further includes a reciprocating movement along the second direction, and the slitting assembly 220 is configured to slit the food material exposed below the material storage cavity 214.

Referring to FIGS. 5 to 8, in some embodiments, the slitting tool 222 is connected to the slitting driving part 221, the slitting driving part 221 is connected to the circulating part 223, the circulating part 223 is connected to the slitting tool 222, the slitting driving part 221 drives the slitting tool 222 and the circulating part 223 simultaneously. The slitting tool 222 moves along the third direction and passes through the material outlet under the drive of the slitting driving part 221 to slit the food material exposed at the material outlet 213, the circulating part 223 also drives the slitting tool 222 to move back and forth along the second direction in a process of that the slitting tool 222 moves along the third direction, the second direction intersects with the third direction, which can achieve the food material cutting in a manner simulating manual food cutting and improve the cutting quality.

It should be understood that the second direction may be perpendicular to the third direction, compared with non-perpendicularity, the second direction perpendicular to the third direction facilitates the driving connection between the slitting driving part 221 and the circulating part 223 through a standard bevel gear, simplifying the difficulty of implementation.

Specifically, the slitting driving part 221 includes a servo motor and a ball screw, the slitting tool 222 is connected to a ball screw slider. Under the drive of the servo motor, the screw slider drives the slitting tool 222 to move along the third direction to cut the food material exposed outside the material storage body 211. The circulating part 223 includes a cylindrical cam and a guide rail slider, along the third direction, the cylindrical cam is arranged at an end of the ball screw that is away from the servo motor, the cylindrical cam is driven to rotate by a bevel gear, the cylindrical cam drives the guide rail slider to move back and forth along the second direction while rotating, the guide rail slider is connected to the slitting tool 222. Thus, when the slitting driving part 221 drives the slitting tool 222 to move along the third direction, the slitting tool 222 also includes a reciprocating movement along the second direction, and when slitting the food material exposed below the material storage cavity 214, the slitting tool 222 can simulate the manner of manually cutting the food material, which improves the slitting quality and efficiency of the food material.

In other embodiments, the circulating part 223 is connected to the slitting driving part 221, the slitting driving part 221 is connected to the slitting tool 222, the circulating part 223 can drive the slitting driving part 221 and the slitting tool 222 to jointly move back and forth along the second direction, the slitting driving part 221 also drives the slitting tool 222 to move along the third direction when the slitting tool 222 moves back and forth along the second direction, which can cut the food material in a manner of simulating the manual cutting and is helpful to improve the cutting quality of the food material.

Referring to FIGS. 5 to 8, in some embodiments, the material storage body 211 is provided with an avoidance part 215, and the slitting device 200 further includes a clamping assembly 230 that is located at the avoidance part 215. Specifically, the clamping assembly 230 includes a clamping driving part 231 and a clamping part 232, the part of the clamping part 232 is located at the avoidance part 215, the avoidance part 215 communicates with the material storage cavity 214, the clamping part 232 can enter the material storage cavity 214 through the avoidance part 215 to fix the food material and prevent the food material from sliding out of the material storage cavity 214. Specifically, the food material enters from the material inlet 212 of the material storage body 211, the clamping assembly 230 fixes the food material located in the material storage cavity 214, a part of food material is exposed outside the material storage cavity 214, the slitting tool 222 slits the food material exposed outside the material storage cavity 214 under the reciprocating movement along the second direction and the movement along the third direction. After slitting, the clamping assembly 230 exits the avoidance part 215, and the food material falls due to gravity. The clamping assembly 230 fixes the to-be-slit part in the material storage cavity 214 again, and the arrangement of the clamping assembly 230 can make the food material more stable when being slit, avoid the food material moving during cutting, and improve the cutting quality of the food material.

Referring to FIGS. 5 to 8, in some embodiments, the clamping assembly 230 includes a clamping driving part 231 and at least two clamping parts 232. Along the first direction, the clamping parts 232 are distributed around the material storage body 211, correspondingly, the avoidance part 215 and the clamping parts 232 have the same quantity. Along the first direction, the avoidance part 215 is distributed on a side wall of the material storage body 211 and at a position corresponding to the clamping parts 232, the clamping parts 232 are located at the avoidance part 215, the clamping driving part 231 drives each of the clamping parts 232 to enter or exit the material storage cavity 214 through the avoidance part 215. The clamping parts 232 cooperate with each other, to fix the food material in the material storage cavity 214 and improve the slitting stability of the slitting tool 222.

Specifically, the clamping driving part 231 can be the servo motor, each clamping part 232 can be the ball screw, the main part of the ball screw is located outside the material storage cavity 214, a part of the screw slider is located at the avoidance part 215, and the servo motor is connected to each ball screw through belt drive and gear drive. In the clamping assembly 230, a plurality of clamping parts 232 can be driven to move by one serve motor only. Compared with the arrangement of a plurality of servo motors, providing one serve motor is helpful to simplify the structure, and a better cooperation can be formed between the ball screws, thereby avoiding an error caused by performance differences between the plurality of servo motors.

Referring to FIGS. 1 to 8, according to the embodiment in the third aspect of the present disclosure, the food cutting apparatus 300 includes a slitting device 200 and the cutting device 100 in any of the above embodiments. The slitting device 200 includes a material storage assembly 210 and a slitting assembly 220, the material storage assembly 210 includes a material storage body 211. A material inlet 212, a material outlet 213 and a material storage cavity 214 that the food material can pass in turn are provided on the material storage body 211. Along the first direction, the slitting assembly 220 is located below the material storage assembly 210, that is, the slitting assembly 220 is located on the side of the material storage body 211 that is provided with the material outlet 213, and the slitting assembly 220 is configured to slit the food material exposed below the material storage cavity 214. Along the second direction, the placing part 124 is movable between the slitting assembly 220 and the cutting assembly 110, the placing part 124 is configured to carry the food material slit by the slitting assembly 220 and transport the slit food material to the cutting assembly 110 for cutting. Thus, the food cutting apparatus 300 can achieve slitting and cutting of the food material, the slitting assembly 220 can slit the relatively big food material into set sizes, the placing part 124 can transport the food material slit by the slitting assembly 220 to the cutting assembly, the identification part 125 identifies the contour information of the food material on the placing part 124, the moving assembly 120 fixes the food material according to the contour information identified by the identification part 125 and adjusts the relative position between the food material and the cutting assembly 110, so as to adjust the cutting position of the cutting assembly 110 the food material, thus providing more refined cutting and ensuring the cutting quality of the food material.

Referring to FIGS. 5 to 8, in some embodiments, the slitting assembly 220 includes a slitting driving part 221 and a slitting tool 222, and the slitting driving part 221 is connected to the slitting tool 222. Under the drive of the slitting driving part 221, the slitting tool 222 is close to or away from the material storage body 211 along the third direction for slitting the food material, and the third direction intersects with the first direction. Specifically, after the food material is put into the material storage cavity 214 through the material inlet 212, the food material will leave the material storage cavity 214 from the material outlet 213. Along the first direction, the slitting tool 222 is located below the material outlet 213, and along the first direction, the slitting tool 222 can be close to or away from the material storage body 211 to slit the food material at the material outlet 213. The slitting driving part 221 may include the servo motor and the ball screw, the slitting tool 222 is connected to the screw slider on the ball screw, and when the food material is slit once, the slitting tool 222 includes a movement closing to the material storage body 211 along the third direction and an action away from the material storage body 211, such that the food material is slit into a to-be-slit part and a slit part. The to-be-slit part is located in the material storage cavity 214, the slit part is transported to the place where the cutting assembly 110 is located along the second direction through the placing part 124, thus further cutting the food material.

It should be noted that at least two of the above-mentioned first direction, second direction and third direction may be perpendicular to each other, so as to be more consistent with standardization and reduce the production cost of each assembly.

Referring to FIGS. 5 to 8, in some embodiments, the slitting assembly 220 further includes a circulating part 223, the circulating part 223 is arranged adjacent to the slitting tool 222 along the second direction, and the circulating part 223 is connected to the slitting driving part 221 and the slitting tool 222. The circulating part 223 includes a cylindrical cam and a sliding guide rail, the sliding guide rail is connected to the cylindrical cam, the cylindrical cam is connected to the slitting driving part 221, under the drive of the slitting driving part 221, the sliding guide rail moves back and forth along the second direction, thereby driving the slitting tool 222 to move back and forth along the second direction. Therefore, under the joint action of the slitting driving part 221 and the circulating part 223, the slitting tool 222 further includes the reciprocating movement along the second direction when moving along the third direction, and the slitting movement of the slitting tool 222 in the food cutting apparatus 300 can better simulate the manual food cutting method, which improves the cutting quality and cutting speed of the food material.

Referring to FIGS. 5 to 8, in some embodiments, the slitting device 200 on the food cutting apparatus 300 further includes a clamping assembly 230, the material storage body 211 is provided with an avoidance part 215, the clamping assembly 230 is located at the avoidance part 215, the avoidance part 215 communicates with the material storage cavity 214, the clamping assembly 230 is capable of entering or exiting the material storage cavity 214 through the avoidance part 215, the clamping assembly 230 enters the material storage cavity 214 to fix the food material, which ensures the stability of the slitting tool 222 when slitting the food material, allows the slitting surface of the food material to be more uniform, and improves the dish quality.

Referring to FIGS. 5 to 8, in some embodiments, the clamping assembly 230 on the food cutting apparatus 300 includes a clamping driving part 231 and at least two clamping parts 232, the clamping driving part 231 is connected to each of the clamping parts 232, along the first direction, the clamping parts 232 are distributed around the material storage body 211, and each of the clamping parts 232 are located at the avoidance part 215. It should be understood that the avoidance part 215 and the clamping parts 232 have the same quantity and are arranged correspondingly. Compared with the arrangement of a plurality of power sources, driven by a single power source of the clamping driving part 231, each of the clamping parts 232 is capable of entering or exiting the material storage cavity 214 through the avoidance part 215, which simplifies the overall structure of the food cutting apparatus 300, also facilitates cooperation between each of the clamping parts 232 and reduces the error generated between different power sources.

Referring to FIGS. 1 to 8, according to the embodiment of the present disclosure, the food cutting method adopts the food cutting apparatus 300 in any of the above embodiments to cut food. The specific food cutting steps include feeding, slitting and transporting, and scanning and cutting, putting the food material from the material inlet 212, the food material entering the material storage cavity 214. Under the action of gravity, the food material falling onto the placing part 124, and a part of the food material being located in the material storage cavity 214. Along the first direction, the height of the exposed food material being that from the placing part 124 to an unloading opening.

Along the first direction, the slitting assembly 220 is located below the material storage body 211, the slitting assembly 220 slits the food material into a to-be-slit part and a slit part. The to-be-slit part is located in the material storage cavity 214 and the slit part is located on the placing part 124, along the second direction, the placing part 124 transports the slit part to the bottom of the identification part 125. The identification part 125 includes a camera that can photograph the food material on the placing part 124 and upload photos to a visual recognition terminal for contour extraction and analysis. The placing part 124 continues to transport the food material to the bottom of the connecting part 123 along the second direction, the connecting part 123 is coupled with the food material, and the moving part and the rotating part 126 jointly translate and rotate the food material to adjust the relative position of the food material and the cutting assembly 110 to perform various processes such as cutting and peeling the food material. During cutting, the identification part 125 can photograph and analyze the food material on the placing part 124 for multiple times to adjust the cutting position of the cutting assembly 110 on the food material, thus meeting various cutting methods of the food material and meeting the processing requirements of the food material of different types or shapes.

Referring to FIGS. 5 to 8, in some embodiments, in the above-mentioned feeding step, the food cutting apparatus 300 further includes a clamping assembly 230, a side wall of the material storage body 211 is provided with an avoidance part 215, and the clamping assembly 230 enters the material storage cavity 214 through the avoidance part 215 to fix the to-be-slit part. Specifically, the food material is put into the material storage cavity 214 through the material inlet 212. Under the action of gravity, the food material falls onto the placing part 124 that moves to the bottom of the material storage body 211, the placing part 124 supports the food material, the slitting tool 222 is located between the placing part 124 and the material storage body 211. The slitting tool 222 is configured to slit the food material into the to-be-slit part and the slit part, the placing part 124 transports the slit part to the next process, and the clamping assembly 230 fixes the to-be-slit part in the material storage cavity 214 to prevent the to-be-slit part from falling.

For example, the clamping assembly 230 includes a clamping driving part 231 and three clamping parts 232. The clamping driving part 231 includes a servo motor, each clamping part 232 includes a ball screw, the clamping driving part 231 and each of the clamping parts 232 are driven through gears and synchronous belts. Along the first direction, the three clamping parts 232 are distributed around the material storage body 211, an included angle between two adjacent clamping parts 232 is 120°, the material storage body 211 is provided with an avoidance part 215, the clamping parts 232 are located in the avoidance part 215, under the drive the clamping driving part 231. The three clamping parts 232 can synchronously enter the material storage cavity 214 to clamp the food material, and can also synchronously exit the material storage cavity 214 to loosen the clamping of the food material, so that the food material can fall onto the lower placing part 124. Compared with the arrangement of a plurality of power sources, driving the three clamping parts 232 simultaneously through the clamping driving part 231 can simplify the structure of the food cutting apparatus 300. In addition, the three clamping parts 232 can clamp the food material from three directions, which is convenient to improve the clamping stability of the food material.

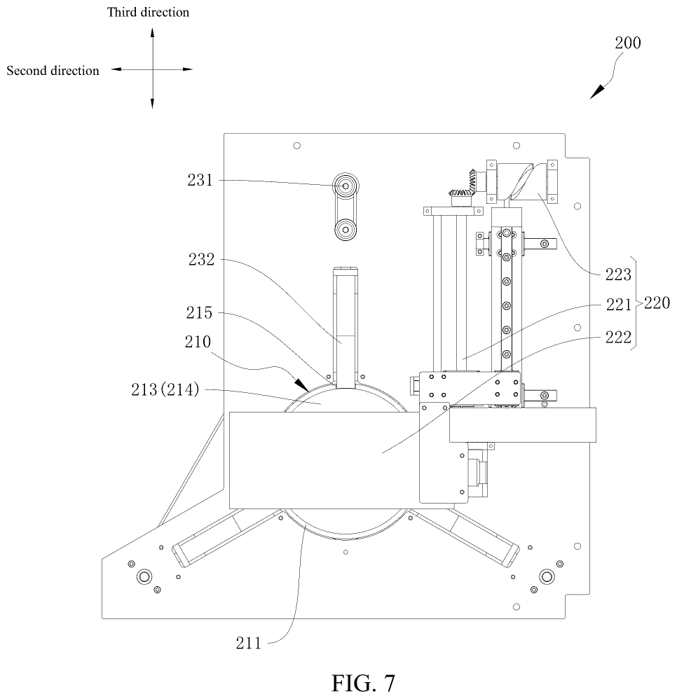

Referring to FIG. 7, in some embodiments, in the slitting and transporting step, the slitting assembly 220 includes a slitting tool 222, when approaching to the material storage body 211 along the third direction, the slitting tool 222 further includes a cyclic reciprocating movement along the second direction, under a combined movement of the two movements, the slitting tool 222 slits the food material located outside the material storage cavity 214, and divides the food material into the to-be-slit part and the slit part. Therefore, the slitting tool 222 can better simulate the manual cutting method when slitting the food material, which helps to improve the uniformity of the slitting surface and ensure the dish quality.

Specifically, the slitting assembly 220 further includes a slitting driving part 221, a circulating part 223 and a slitting tool 222, the slitting driving part 221 includes a servo motor and a ball screw, a sliding part of the ball screw is connected to the slitting tool 222, one end of the ball screw is connected to the slitting driving part 221 while the other end is connected to the circulating part 223. The circulating part 223 includes a cylindrical cam and a sliding guide rail, a slider part of the sliding guide rail is connected to the cylindrical cam, and the cylindrical cam is connected to the ball screw. Under the drive of the servo motor, a first slider on the ball screw drives the slitting tool 222 to move along the third direction, and the slider part on the sliding guide rail drives the slitting tool 222 to move back and forth along the second direction. Thus, the slitting tool 222 slits the food material under the combined movement in the above two directions.

Referring to FIGS. 1 to 4, in some embodiments, in the scanning and cutting step, when the food material approaches to the cutting assembly 110 along the second direction, the moving assembly 120 can also drive the food material to rotate. Thus, under the drive of the moving assembly 120, the food material can be lifted, translated and rotated to achieve the cutting of the food material at any position without dead ends, which improves the adaptability of the food material.

Specifically, the moving assembly 120 includes a driving part 122, a rotating part 126 and a connecting part 123, both the rotating part 126 and the connecting part 123 are connected to the driving part 122, the driving part 122 includes a first motor 1221, a second motor 1222 and a third motor 1223. The connecting part 123 is connected to the third motor 1223, the third motor 1223 is configured to drive the connecting part 123 to rise or fall along the first direction, the second motor 1222 is connected to the rotating part 126. Under the drive of the second motor 1222, the third motor 1223 and the connecting part 123 rotate around the axial direction of the connecting part 123, the axial direction of the connecting part 123 is parallel to the first direction. Under the drive of the first motor 1221, the rotating part 126 and the connecting part 123 move along the second direction, thus driving the food material to approach to the cutting assembly 110. Therefore, the food material can move in three directions when being cut, the cutting assembly 110 can cut the food material at any position of the food material, when the food material is cut, the identification part 125 can also photograph the food material for contour analysis, and the relative position between the food material and the cutting assembly 110 can be adjusted according to the analyzed contour information.

The embodiments of the present disclosure are described in detail above in combination with the drawings, and however the present disclosure is not limited the above embodiments. Under the premise of not departing from the purpose of the present disclosure, various changes may also be made within the knowledge scope of those skilled in the art. In addition, the embodiments in the present disclosure and features in the embodiments may be combined with each other without conflict.

What is claimed is:

1. A cutting device, comprising:
a cutting assembly configured to cut a food material;
a moving assembly comprising a fixing part, a driving part, a connecting part and a placing part, wherein the driving part is connected to the fixing part, the connecting part is connected to the driving part, the connecting part is located between the fixing part and the placing part along a first direction, the placing part is arranged adjacent to the cutting assembly along a second direction, the placing part is configured to carry the food material, the driving part is configured to drive the connecting part to be close to or away from the placing part along the first direction, the food material is capable of being fixed between the connecting part and the placing part, and the driving part is capable of driving the connecting part to be close to or away from the cutting assembly along the second direction, to adjust a cutting position of the cutting assembly on the food material; and
an identification part connected to the fixing part, wherein the identification part is located below the fixing part along the first direction, and the identification part is configured to identify contour information of the food material on the placing part and feed back the contour information to the driving part.

2. The cutting device according to claim 1, wherein the moving assembly further comprises a rotating part, the rotating part is connected to the driving part and the connecting part, the driving part drives the rotating part to rotate around the first direction, the rotating part drives the connecting part to rotate, and the connecting part is capable of driving the food material to rotate along an axial direction of rotation of the connecting part, to adjust the cutting position.

3. The cutting device according to claim 1, wherein the placing part is provided with an avoidance slot extending along the second direction, the avoidance slot is located below the connecting part and arranged corresponding to the connecting part along the first direction, and the avoidance slot is configured to avoid the connecting part.

4. A food cutting apparatus, comprising:
a slitting device comprising a material storage assembly and a slitting assembly, wherein the material storage assembly comprises a material storage body provided with a material storage cavity for accommodating a food material, a material inlet through which the food material enters the material storage cavity and a material outlet through which the food material is exposed to the material storage cavity; and along a first direction; and wherein the slitting assembly is located on a side of the material storage body that is provided with the material outlet, and the slitting assembly is configured to slit the food material exposed at the material outlet; and
a cutting device, comprising:
a cutting assembly configured to cut a food material;
a moving assembly comprising a fixing part, a driving part, a connecting part and a placing part, wherein the driving part is connected to the fixing part, the connecting part is connected to the driving part, the connecting part is located between the fixing part and the placing part along a first direction, the placing part is arranged adjacent to the cutting assembly along a second direction, the placing part is configured to carry the food material, the driving part is configured to drive the connecting part to be close to or away from the placing part along the first direction, the food material is capable of being fixed between the connecting part and the placing part, and the driving part is capable of driving the connecting part to be close to or away from the cutting assembly along the second direction, to adjust a cutting position of the cutting assembly on the food material; and
an identification part connected to the fixing part, wherein the identification part is located below the fixing part along the first direction, and the identification part is configured to identify contour information of the food material on the placing part and feed back the contour information to the driving part;
wherein the placing part is movable between the slitting assembly and the cutting assembly, and the placing part is configured to carry the food material slit by the slitting assembly and transport the food material to the cutting assembly for cutting.

5. The food cutting apparatus according to claim 4, wherein the slitting assembly comprises a slitting driving part and a slitting tool, the slitting driving part is connected to the slitting tool, the slitting tool is located on the side of the material storage body that is provided with the material outlet, the slitting driving part is configured to drive the slitting tool to move along a third direction and pass through the material outlet, to slit the food material exposed at the material outlet, and the third direction intersects with the first direction.

6. The food cutting apparatus according to claim 5, wherein the slitting assembly further comprises a circulating part, the circulating part is arranged adjacent to the slitting driving part along the second direction, the circulating part is connected to the slitting driving part and the slitting tool, the circulating part is configured to drive the slitting tool to move back and forth along the second direction in a process of the slitting tool moving along the third direction, and the second direction intersects with the third direction.

7. The food cutting apparatus according to claim 5, wherein the slitting assembly further comprises a circulating part, the circulating part is arranged adjacent to the slitting driving part along the second direction, the circulating part is connected to the slitting driving part, the circulating part is configured to drive the slitting driving part to move back and forth along the second direction in a process of the slitting tool moving along the third direction, and the second direction intersects with the third direction.

8. The food cutting apparatus according to claim 4, wherein the slitting device further comprises a clamping assembly, the material storage body is provided with an avoidance part, the clamping assembly is located at the avoidance part, the avoidance part communicates with the material storage cavity, the clamping assembly is capable of entering or exiting the material storage cavity through the avoidance part, and the clamping assembly enters the material storage cavity for fixing the food material.

9. The food cutting apparatus according to claim 8, wherein the clamping assembly comprises a clamping driving part and at least two clamping parts, the clamping driving part is connected to each of the clamping parts; and along the first direction, the clamping parts are distributed around the material storage body and located at the avoidance part, the clamping driving part drives each of the clamping parts to enter or exit the material storage cavity through the avoidance part for fixing or releasing the food material.
